(19) United States
(12) Patent Application Publication
(10) Pub. No.: US 2017/0197547 A1
(43) Pub. Date: Jul. 13, 2017

(54) ALARM SYSTEM

(71) Applicant: Victor Salinas, JR., League, TX (US)

(72) Inventor: Victor Salinas, JR., League, TX (US)

(21) Appl. No.: 14/992,010

(22) Filed: Jan. 10, 2016

(51) Int. Cl. B60Q 9/00; B60R 21/015

(52) U.S. Cl. CPC B60Q 9/00; B60R 21/01516

(57) ABSTRACT

The invention is directed to an alarm system for safety of infants from being left out in vehicles and comprises a pressure sensor, batteries, speaker, multiple set of actuating buttons and a recorder embodied inside a cushioned pillow or back rest. The alarm system uses the pressure sensor by locating it inside a back rest preferably used by the driver of a vehicle. The alarm system of the present disclosure further is in the form of a recorder connected to the pressure sensor and speaker and functions using battery power.

### FIELD OF THE INVENTION

The present invention relates to an occupant notification system and more particularly in reminding occupants getting out of a vehicle that there is a child fastened in a car seat inside the vehicle at the rear.

### BACKGROUND OF THE INVENTION

Generally, babies, newborns, and infants are left unattended in the vehicle and there are more and more tragic incidences of busy parents, daycare workers, and other adults in a hurry or in a preoccupied state of mind, getting our of their car and forgetting that a baby or small child is strapped in the car seat in the back seat of the car. Such events can change the lives of a family permanently. For a reasonably low cost, car seats can be equipped with a notification system that will get a responsible adult's attention when leaving a vehicle, thereby preventing such accidents from occurring.

The use of warning systems and car seat safety devices are known in the prior art. For example, U.S. Pat. No. 7,012,533 issued to Younse discloses a child car seat with a built-in cushion switch that closes when the seat is occupied. Also, push type switches are added to at least one of the vehicle's side passenger doors with signals being routed to a micro-controller unit, which determines when the car seat is occupied and when one of the doors is open and enables the vehicle's internal beeper alarm, thereby reminding any occupants exiting the vehicle that a child is strapped in the back seat.

U.S. Pat. No. 7,319,382B1, issued to Bach Vu discloses a child seat occupant warning system for an auto, comprising a sensor detecting the connection of the removable seat to the seat base, comprising a central processing unit that communicates with a sensor in the driver seat of the auto, a vibration sensor sensing engine operation of the auto, a GPS transmitter with delay, and a low battery warning mechanism, whereby engine cessation, driver absence and seat base connection to child seat triggers an audio alarm to remind a driver to remove the child from the vehicle, the system reset by removing the child seat from the base.

U.S. Pat. Application No. 20120007741, issued to Laffey discloses an apparatus for warning a driver of a car that a child, pet or valuable is still in the car when an attempt is made by the driver to lock the car doors after the car is parked and the engine is turned off comprising a keyless remote entry device having a door unlocking button and a door locking button; at least one button on the keyless remote entry device which, when first pressed, shows that a child, pet or valuable is being placed in the car; a control circuit coupled to the keyless remote entry device; and an alarm circuit controlled by the control circuit; wherein the keyless remote entry device cannot be used to lock the car doors when a child, pet or valuable is still in the car after the car engine is turned off and the button has not been pressed a second time to alert the remote entry device that the child, pet or valuable has been removed from the car.

U.S. Pat. No. 20120232749, issued to Schoenberg discloses a system and method which provide for an alarm or notification that a child is in a car seat. The system generally determines if a child is in the seat and that the seat, and therefore the vehicle, is not in motion. Upon detecting both situations, a notification or alarm is activated. The system will generally provide for an alarm to a smartphone or other remote notification device to improve the likelihood that the alarm will be received. While the method and systems of the prior art fulfill their respective, particular objectives and requirements, the aforementioned patents do not disclose a pressure based system housed in a driver's pillow cushion with a alarm unit that sounds as soon as the driver releases pressure on the pillow cushion in an attempt to move out of the vehicle. Therefore what is needed is a simple and inexpensive pressure actuated system that prevents infants being left unattended in vehicles.

### SUMMARY OF THE INVENTION

An improved alarm system installed in a driver's back or cushioned pillow is dislosed. The alarm system is for the safety of infants from being left unattended in vehicles by using a pressure sensor, batteries, speaker, and a recorder housed inside the cushioned pillow. The alarm system uses the pressure sensor by locating it inside a back rest preferably used by the driver of a vehicle. The alarm system of the present disclosure further is in the form of a recorder connected to the pressure sensor and speaker and functions using battery power.

It is an object of the present invention to provide an alarm system located inside the back pillow of a vehicle used by its driver.

These and other features of the present invention will become readily apparent upon further review of the following specification and drawings.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is a perspective view of a pillow or back cushion housing the alarm system in accordance with one embodiment of the present invention.

Similar reference characters denote corresponding features consistently throughout the attached drawings.

### DETAILED DESCRIPTION OF THE INVENTION

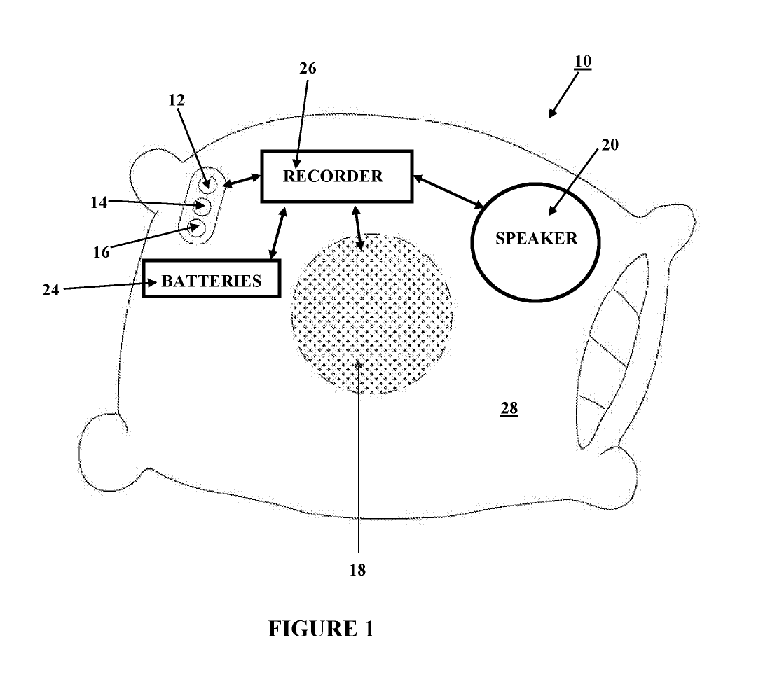

Referring now to FIG. 1, there is shown a new and improved alarm system 10 used for the safety of infants from being left out in vehicles. The alarm system 10 comprises a pressure sensor 18, batteries 24, speaker 20, multiple set of actuating buttons 12, 14, 16 and a recorder 26 all electrically connected and housed inside a cushioned pillow or back rest 28. The alarm system 10 with pressure sensor 18 located inside the back rest 28 is preferably used by the driver of a vehicle (not shown). The alarm system 10 recorder 26 is connected to the pressure sensor 18 and speaker 20 and functions using battery power 24 with the batteries selected from easy to replace types or rechargeable types. The back rest 28 is cushioned providing better safety to the components housed inside the back rest 28 and may in the form of a cushioned pillow made of fabric selected from the group consisting of cotton, polyester, wool. The back rest 28 is further removably fastened to a vehicle seat (not shown) using fastening means selected from the group consisting of an elastic, Velcro or fabric glue (not shown).

In use, the recorder 26 of alarm system 10 is activated using pressure sensor 18 wherein speaker 20 sounds to remind the driver upon exiting their vehicle about the presence of a child present in the vehicle's rear seat (not shown). In another preferred embodiment, the recorder 26 is used to record and store at least one statement for reminding the driver about the child sitting at the rear. The statements can be pre-recorded as preferred by the user and includes statements like “Mom/Dad, I'm in the back seat”, “Mom/Dad take me along”, “Mom/Dad don't leave me here please”. The user/driver can select the statement that can be later used as an alarm by using a set of actuating buttons 12, 14 and 16. Turning once again to FIG. 1, the first actuating button 12 may be used for controlling the on and off function of recorder 26. The second button 14 may be used for controlling the volume of speaker 20 wherein the third button 16 may be used for selecting a pre-recorded statement from the recorder 26.

In accordance with the method of the present invention using the alarm system 10 for the safety of infants from being left out in vehicles, comprises the following steps:
attaching the back rest in the driver's seat of the vehicle wherein the back rest comprises a pressure sensor, batteries, speaker, recorder, actuating buttons;
applying pressure on the back rest by the driver's back;
activating the sensor when pressure is applied;
releasing pressure on the sensor in an attempt to leave the vehicle;
activating the recorder connected to the sensor;
activating the speaker connected to the recorder;
sounding the alarm from the recorder;
reminding the driver of the presence of the child in the vehicle.

It is contemplated within the scope of the present inventon that any other type of toy or device may also be incorporated such as a vibrating infant garment, and may also include but is not limited to sounds, audio, notifications, alerts, visual alerts, video, pictures, or digital media. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. An alarm system for safety of infants from being left out in vehicles comprises of: pressure sensor, batteries, speaker, recorder, buttons and back rest.

2. An alarm system as claimed in claim 1, wherein the back rest is cushioned.

3. An alarm system as claimed in claim 1, wherein the back rest further comprises of a pressure sensor, batteries, speaker, buttons and recorder.

4. An alarm system as claimed in claim 1, wherein the back rest is removably attached to driver seat of the vehicle.

5. An alarm system as claimed in claim 1, wherein the back rest is attached to the seat using fastening means.

6. An alarm system as claimed in claim 1, wherein the fastening means is selected from a group of elastic, Velcro, fabric glue.

7. An alarm system as claimed in claim 1, wherein the back rest is a pillow made of fabric selected from a group of cotton, polyester, wool.

8. An alarm system as claimed in claim 1, wherein the pressure sensor is connected to the recorder.

9. An alarm system as claimed in claim 1, wherein the recorder is connected to the speaker.

10. An alarm system as claimed in claim 1, wherein the system functions using battery power.

11. An alarm system as claimed in claim 1, wherein the batteries that are easily replaced.

12. An alarm system as claimed in claim 1, wherein the batteries that are easily recharged.

13. An alarm system as claimed in claim 1, wherein the buttons is first set, second set and third set of buttons.

14. An alarm system as claimed in claim 1, wherein the first set of buttons is used for controlling on and off function of the recorder.

15. An alarm system as claimed in claim 1, wherein the second set of buttons is used for volume control of the speaker.

16. An alarm system as claimed in claim 1, wherein the third set of buttons is used for selecting pre-recorded statement from the recorder.

17. A method of using an alarm system for safety of infants from being left out in vehicles, the method comprises:
attaching the back rest in the driver's seat of the vehicle wherein the back rest comprises pressure sensor, batteries, speaker, recorder, actuating buttons;
pressure applied on the back rest by driver's back;
activating the sensor with the pressure applied;
releasing pressure on the sensor in an attempt to leave the vehicle;
activating the recorder connected to the sensor;
activating the speaker connected to the recorder;
sounding the alarm from the recorder;
reminding the driver of the presence of the child in the vehicle;
wherein the alarm is pre-recorded statement acting as reminder of the child present in the rear seat.

18. A method of using an alarm system as claimed in claim 17, wherein the back rest is attached to the seat using fastening means.

19. A method of using an alarm system as claimed in claim 17, wherein the fastening means is selected from a group of elastic, Velcro, fabric glue.

20. A method of using an alarm system as claimed in claim 17, wherein the statements can be selected from the group of pre-recorded statements.
